(19) United States
(12) Patent Application Publication
(10) Pub. No.: US 2007/0236146 A1
(43) Pub. Date: Oct. 11, 2007

(54) Plasma display panel and method of fabricating the same

(76) Inventors: Kyoung-Doo Kang, Suwon-si (KR); Won-Ju Yi, Suwon-si (KR); Ho-Young Ahn, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/784,991

(22) Filed: Apr. 9, 2007

(30) Foreign Application Priority Data
Apr. 11, 2006 (KR) 10-2006-0032661

(51) Int. Cl. H01J 17/49

(52) U.S. Cl. 313/585; 313/582

(57) ABSTRACT

Provided are a plasma display panel and a method of fabricating the same. The plasma display panel includes: a plurality of substrates including a first substrate and a second substrate, which oppose each other; barrier ribs disposed between the substrates and defining a plurality of discharge cells; discharge electrodes buried within the barrier ribs and causing a discharge by an applied power; and a plurality of phosphor layers formed within the discharge cells, wherein the barrier ribs are formed of a plurality of sheets for barrier ribs and the discharge electrodes are patterned in a selected region of the sheets for barrier ribs. Dielectric walls, which are disposed between the substrates and in which a plurality of discharge electrodes are buried, are fabricated using a plurality of sheets through independent processes and are combined with the substrates, such that processes are simplified and thermal deformation during a baking process is minimized.

### CROSS-REFERENCE TO RELATED APPLICATIONS

This application claims the priority of Korean Patent Application No. 10-2006-0032661, filed on Apr. 11, 2006, in the Korean Intellectual Property Office, the disclosure of which is incorporated herein in its entirety by reference.

### BACKGROUND OF THE INVENTION

1. Field of the Invention

The present embodiments relate to a plasma display panel (PDP), and more particularly, to a PDP in which barrier ribs in which discharge electrodes are buried and in which partition discharge cells are separated from substrates, and a method of fabricating the same.

2. Description of the Related Art

Plasma display panels (PDP) are flat display devices in which a discharge gas is injected into a plurality of substrates and sealed between the substrates and, if a gas discharge occurs due to a voltage applied to a plurality of discharge electrodes, a phosphor layer is excited by ultraviolet rays generated in a discharge process and visible rays are emitted such that desired numbers, characters or graphics are realized.

Such PDPs can be classified into DC type PDPs and AC type PDPs according to types of driving voltages applied to discharge cells, for example, according to discharge types, and can be classified into opposed discharge type PDPs and surface discharge type PDPs according to configuration shapes of electrodes.

A 3-electrode surface discharge type PDP includes a first substrate; a second substrate; a sustain discharge electrode pair formed on an inner surface of the first substrate and having an X electrode and a Y electrode; a first dielectric layer burying the sustain discharge electrode pairs; a protective layer coated on a surface of the first dielectric layer; an address electrode formed on an inner surface of the second substrate and disposed to cross the sustain discharge electrode pair; a second dielectric layer burying the address electrode; barrier ribs installed between the first and second substrates; and red, green, and blue phosphor layers formed within discharge cells. In the meantime, a discharge gas is injected into an inner space in which the first and second substrates are combined with each other, thereby forming a discharge region.

In a conventional PDP having the above structure, electrical signals are applied to an X electrode and an address electrode so that a discharge cell is selected, and then electrical signals are alternately applied to an X electrode and a Y electrode and a surface discharge occurs from a surface of the first substrate, ultraviolet rays are generated, visible rays are emitted from a phosphor layer of the selected discharge cell whereby still images or moving pictures can be realized.

However, conventional PDPs have the following problems.

Firstly, the sustain discharge electrode pair is patterned on the inner surface of the first substrate, the sustain discharge electrode pair is buried by the first dielectric layer and a protective layer is deposited on the surface of the first dielectric layer. In addition, an address electrode is patterned on an inner surface of a second substrate, the address electrode is buried by a second dielectric layer and barrier ribs are formed on a surface of the second dielectric layer. Subsequently, the first substrate and the second substrate are aligned and assembled with each other. In this way, respective discharge electrodes, a dielectric layer burying the discharge electrodes, a protective layer or barrier ribs are formed by a complicated fabrication process.

Secondly, since the sustain discharge electrode pair, the dielectric layer burying the sustain discharge electrode pair and the protective layer are formed on the inner surface of the first substrate, transmission of visible rays is just 60% and brightness is lowered.

Thirdly, a discharge is fired from a discharge gap of the sustain discharge electrode pair and is diffused to both edges of the sustain discharge electrode pair. That is, since the discharge is diffused along a plane of the first substrate, the entire space utilization degree of the discharge cells is low.

Fourthly, since a discharge is diffused toward a phosphor layer during long term driving, charged particles of a discharge gas cause ion sputtering on the phosphor by an electric field, thereby causing a permanent burning image.

Fifthly, if a 10 volume % or higher-concentration Xe gas is applied into discharge cells, due to ionization of atoms and excitation reaction, the amount of charge particles and excited species generated increases such that brightness and discharge efficiency increase. However, for the reason of applying the high-concentration Xe gas, an initial discharge firing voltage increases.

### SUMMARY OF THE INVENTION

The present embodiments provide a plasma display panel (PDP) in which barrier ribs which are disposed between substrates, partition discharge cells and in which discharge electrodes are buried, are fabricated by an additional process using a plurality of film sheets and the substrates and the barrier ribs are combined with one another, and a method of fabricating the same.

According to an aspect of the present embodiments, there is provided a plasma display panel including: a plurality of substrates including a first substrate and a second substrate, which oppose each other; barrier ribs disposed between the substrates and defining a plurality of discharge cells; discharge electrodes buried within the barrier ribs and causing a discharge by an applied power; and a plurality of phosphor layers formed within the discharge cells, wherein the barrier ribs are formed of a plurality of sheets for barrier ribs and the discharge electrodes are patterned in a selected region of the sheets for barrier ribs.

The plasma display panel may further include a protective layer formed on an outer surface of each barrier rib.

The barrier ribs may be formed by stacking a plurality of sheets for barrier ribs in the same direction as a direction in which the substrates are disposed.

The discharge electrodes may be disposed in a direction perpendicular to the direction in which the substrates are disposed and may be formed to surround circumferences of the discharge cells.

The discharge electrodes may include: a first discharge electrode; a second discharge electrode extending in the same direction as that of the first discharge electrode and causing a sustain discharge; and a third discharge electrode extending in a direction which crosses the second discharge electrode and causing an addressing discharge.

The discharge electrodes may be disposed in a region where they face one another based on each of discharge cells.

The discharge electrodes may be disposed on the same plane within the barrier ribs and may be electrically insulated from one another.

A groove having a predetermined depth may be formed in a region corresponding to each of discharge cells and the phosphor layers may be formed in the groove.

According to another aspect of the present embodiments, there is provided a method of fabricating a plasma display panel, the method including: preparing a plurality of substrates including a first substrate and a second substrate, which are disposed to be parallel to each other; preparing barrier ribs disposed between the substrates and partitioning a plurality of discharge cells and formed by stacking a plurality of sheets for barrier ribs in which a plurality of discharge electrode pairs are buried, in one direction; and aligning the barrier ribs between the first and second substrates and forming a sealed discharge space by combining the barrier ribs.

The preparing of the barrier ribs may include: forming the discharge electrodes in a selected region of a plurality of sheets for barrier ribs; and sequentially stacking the sheets for barrier ribs and then forming openings in regions corresponding to discharge cells.

The openings may be processed by punching or etching, thereby forming discharge cells.

The method may further include forming a protective layer on an outer surface of each barrier rib.

The preparing of the substrates may include: forming a groove in a region corresponding to each of discharge cells on the substrates; and forming a plurality of phosphor layers in the groove.

### BRIEF DESCRIPTION OF THE DRAWINGS

The above and other aspects and advantages of the present embodiments will become more apparent by describing in detail exemplary embodiments thereof with reference to the attached drawings in which:

FIG. 1 is a partially-cut separated perspective view of a plasma display panel (PDP) according to an embodiment;

FIG. 2 is a cut cross-sectional view taken along line I-I of FIG. 1;

FIG. 3 is a perspective view of separated discharge electrodes of FIG. 1;

FIG. 4 is a separated perspective view illustrating the state where the PDP illustrated in FIG. 1 is fabricated;

FIG. 5 is a separated perspective view illustrating the state where a PDP according to another embodiment is fabricated;

FIG. 6 is a partially-cut separated perspective view illustrating the state where a PDP according to another embodiment is fabricated; and

FIG. 7 is a plan view illustrating the state where discharge electrodes illustrated in FIG. 6 are disposed.

### DETAILED DESCRIPTION OF THE INVENTION

The present embodiments will now be described more fully with reference to the accompanying drawings, in which exemplary embodiments are shown.

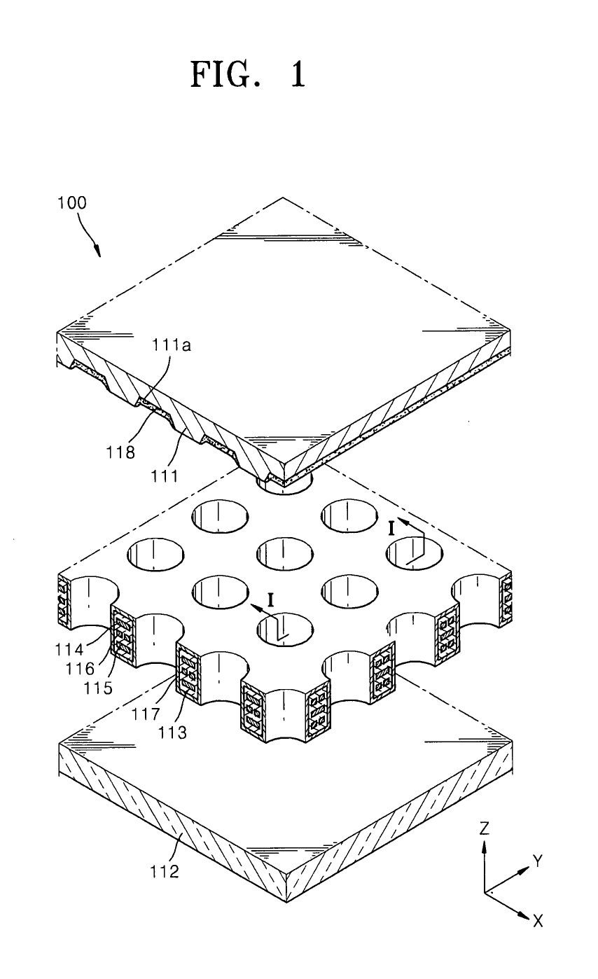

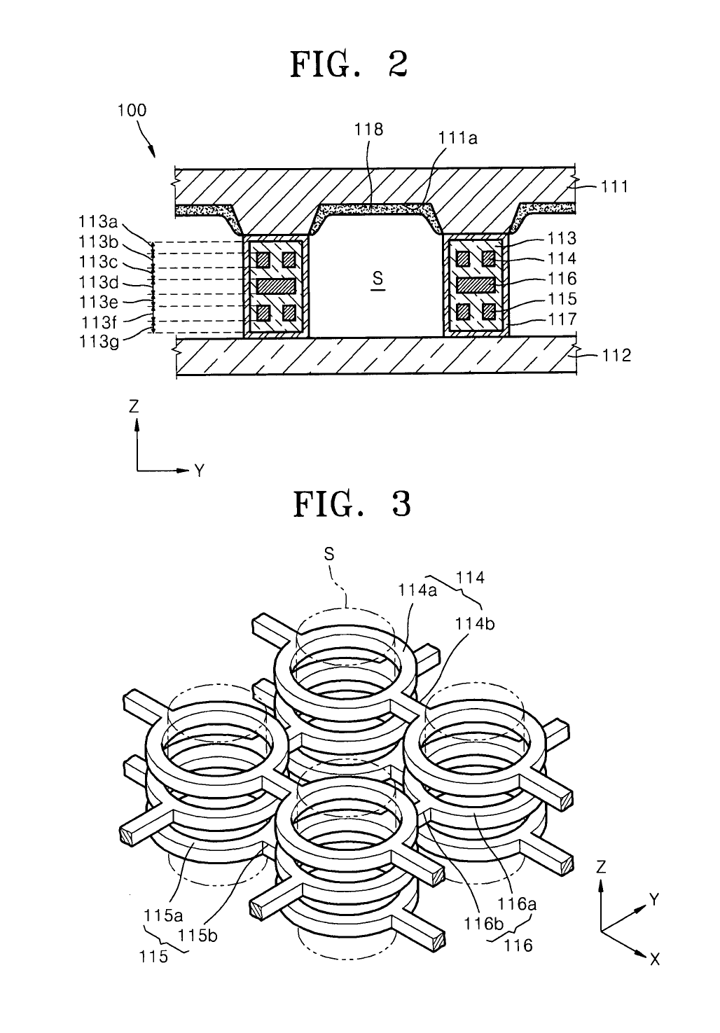

FIG. 1 is a partially-cut separated perspective view of a plasma display panel (PDP) 100 according to an embodiment, FIG. 2 is a cut cross-sectional view taken along line I-I of FIG. 1, and FIG. 3 is a perspective view of separated discharge electrodes of FIG. 1.

Referring to FIGS. 1 through 3, the PDP 100 includes a first substrate 111 and a second substrate 112, which oppose each other. The first and second substrates 111 and 112 are formed of a material having excellent light transmissivity, such as glass, but may be formed of colored or transparent films or films having flexibility, so as to improve bright room contrast by lowering reflection brightness.

Barrier ribs 113 are disposed between the first substrate 111 and the second substrate 112. The barrier ribs 110 are formed to partition discharge cells S and to prevent an electrical and optical crosstalk between the adjacent discharge cells S. A plurality of discharge electrode pairs 114, 115 and 116 are disposed within the barrier ribs 113.

The barrier ribs 113 may prevent electricity from directly flowing among the adjacent first through third discharge electrodes 114, 115 and 116, simultaneously may prevent positive ions or electrons from damaging the first through third discharge electrodes 114, 155, and 116 and may be formed of dielectrics which can accumulate wall charges by inducing charges.

In addition, the barrier ribs 113 form the discharge cells S having circular cross-sections but are not limited to this. That is, if the barrier ribs 113 have a structure for partitioning the plurality of discharge cells S, the barrier ribs 113 may be formed to have the discharge cells S with cross-sections of a variety of patterns such as polygonal cross-sections, circular cross-sections or non-circular cross-sections. The barrier ribs 113 may also be formed to define discharge cells of delta types, waffle types or meander types.

The first through third discharge electrodes 114, 155 and 116 are disposed to be spaced apart from one another by a predetermined gap in each of the discharge cells S. The first discharge electrode 114 is disposed to be relatively adjacent to the first substrate 111, the second discharge electrode 115 is disposed to be relatively adjacent to the second substrate 112, and the third discharge electrode 116 is disposed between the first discharge electrode 114 and the second discharge electrode 115.

The first discharge electrode 114 extends to surround a circumference of each of the discharge cells S disposed along an X direction of the PDP 100. The first discharge electrode 114 includes a first loop 114a for surrounding a circumference of each of the discharge cells S in an open loop shape or a closed loop shape, and a first bridge 114b for electrically connecting the adjacent first loops 114a.

The first loop 114a has a circular closed loop shape but is not limited to this and may have a variety of shapes such as rectangular or hexagonal open loops or closed loops. The first loop 114a may have substantially the same shape as the cross-section of each of the discharge cells S.

The second discharge electrode 115 extends to surround a circumference of each of the discharge cells S in the same direction as that of the first discharge electrode 114. The second discharge electrode 115 is disposed to be spaced apart from the first discharge electrode 114 in a direction (a Z direction) perpendicular to a direction in which the PDP 100 is disposed within the barrier ribs 113.

In some embodiments, the second discharge electrode 115 includes a second loop 115a for surrounding a circumference of each of the discharge cells S, and a second bridge 115b for electrically connecting the adjacent second loops 115a. The second loop 115a has a circular closed loop shape but is not limited to this and may have a variety of shapes such as rectangular open loops or closed loops. The second loop 115a may have substantially the same shape as the cross-section of each of the discharge cells S.

In addition, the third discharge electrode 116 extends in a direction which crosses a direction in which the first discharge electrode 114 and the second discharge electrode 115 extend. The third discharge electrode 116 includes a third loop 116a for surrounding each of the discharge cells S disposed in a Y direction of the PDP 100, and a third bridge 116b for electrically connecting the adjacent third loops 116a.

In the current embodiment, the PDP 100 includes three discharge electrodes 114, 115 and 116. The first discharge electrode 114 and the second discharge electrode 115, respectively, correspond to an X electrode and a Y electrode, which cause a sustain discharge. The third discharge electrode 116 corresponds to an address electrode which extends in a direction which crosses the second discharge electrode 115 and causes an address discharge. However, the number or shape of discharge electrodes is not limited to this.

In addition, the first discharge electrode 114, the third discharge electrode 116, and the second discharge electrode 115 are sequentially disposed in the direction (the Z direction) perpendicular to the direction in which the PDP 100 is disposed. However, the arrangement of discharge electrodes is not limited this.

Since the first through third discharge electrodes 114, 115 and 116 are not disposed in a position where transmission of visible rays is directly reduced, such as an inner surface of the first substrate 111 or the second substrate 112, the first through third discharge electrodes 114, 115 and 116 are formed of a metallic material having high conductivity, such as aluminum or copper.

A protective layer 117 may be formed on an outer surface of the barrier ribs 113. The protective layer 117 serves to protect the barrier ribs 113 and the first through third discharge electrodes 114 to 116 from being damaged by sputtering of plasma particles and simultaneously serves to reduce a discharge voltage by emitting secondary electrons. A magnesium oxide (MgO), for example, may be used for the protective layer 117. In the current embodiment, the protective layers 117 are simultaneously formed on upper surfaces, lower surfaces, and sidewalls of the barrier ribs 113 but the present embodiments are not limited to this.

In addition, a groove 111a having a predetermined depth can be formed in a region corresponding to each unit discharge cell S on the inner surface of the first substrate 111. The groove 111a is discontinuously formed in each discharge cell S. The groove 111a has substantially the same shape as that of each discharge cell S.

Phosphor layers 118 are formed in the groove 111a, so as to realize color images of the PDP 100. Alternatively, the phosphor layers 118 may also be formed in other regions. For example, the phosphor layers 118 may be formed directly on the inner surface of the first substrate 111 without forming the groove 111a or may be formed on inner sidewalls of the barrier ribs 113 that contact the discharge cells S or may be formed on the inner surface of the second substrate 112 or may also be formed on all of these locations.

The phosphor layers 118 include components for generating visible rays by receiving ultraviolet rays. In the current embodiment, the phosphor layers 118 include a red phosphor layer, a green phosphor layer, and a blue phosphor layer but are not limited to this. In one embodiment, the red phosphor layer is formed of (Y,Gd)BO₃;Eu+³, the green phosphor layer is formed of Zn₂SiO₄:Mn²⁺, and the blue phosphor layer is formed of BaMgAl₁₀O₁₇:Eu²⁺. However, the present embodiments are not so limited.

In addition, a discharge gas such as Ne—Xe, He—Xe or a mixed gas thereof is sealed within the discharge cells S. In the current embodiment, the discharge surface increases and the discharge area may be enlarged so that the amount of plasma increases and low voltage driving is possible. Thus, even though a high-concentration Xe gas is used as a discharge gas, low voltage driving is possible so that luminous efficiency can be improved.

In this embodiment, the barrier ribs 113 are formed of a plurality of film-shaped sheets for barrier ribs. The sheets for barrier ribs are sequentially stacked in one direction, thereby forming the barrier ribs 113, which will now be described in more detail.

The sheets for the barrier ribs include a first sheet for barrier ribs 113a formed of only material for barrier ribs, a second sheet for barrier ribs 113b which is stacked on the first sheet for barrier ribs 113a and in which the first discharge electrode 114 is patterned, a third sheet for barrier ribs 113c formed of only a material for barrier ribs, a fourth sheet for barrier ribs 113d which is stacked on the third sheet for barrier ribs 113c and in which the third discharge electrode 116 is patterned, a fifth sheet for barrier ribs 113e which is stacked on the fourth sheet for barrier ribs 113d and is formed of only a material for barrier ribs, a sixth sheet for barrier ribs 113f which is stacked on the fifth sheet for barrier ribs 113e and in which the second discharge electrode 115 is patterned, and a seventh sheet for barrier ribs 113g which is stacked on the sixth sheet for barrier ribs 113f and is formed of only a material for barrier ribs.

As an alternative, if the barrier ribs have a stack in which a plurality of sheets for barrier ribs are stacked, the number of the sheets for barrier ribs is not limited to the above-described example and may be larger or smaller than the number in the above-described example.

The first through seventh sheets for barrier ribs 113a to 113g are aligned in the same position in the same direction as a direction where the PDP 100 is disposed, and are sequentially stacked and are processed to form discharge cells S through a subsequent punching or etching process. In addition, the first through seventh sheets for barrier ribs 113a to 113g may also be formed with the second substrate 112 as a single body through drying and baking processes.

Although not shown, the first through seventh sheets for barrier ribs 113a to 113g are sequentially stacked on base films, and protective films are attached onto the first through seventh sheets for barrier ribs 113a to 113g. In addition, when the first through seventh sheets for barrier ribs 113a to 113g are disposed between the first substrate 111 and the second substrate 112, positions thereof are set in the state where the protective films and the base films are removed.

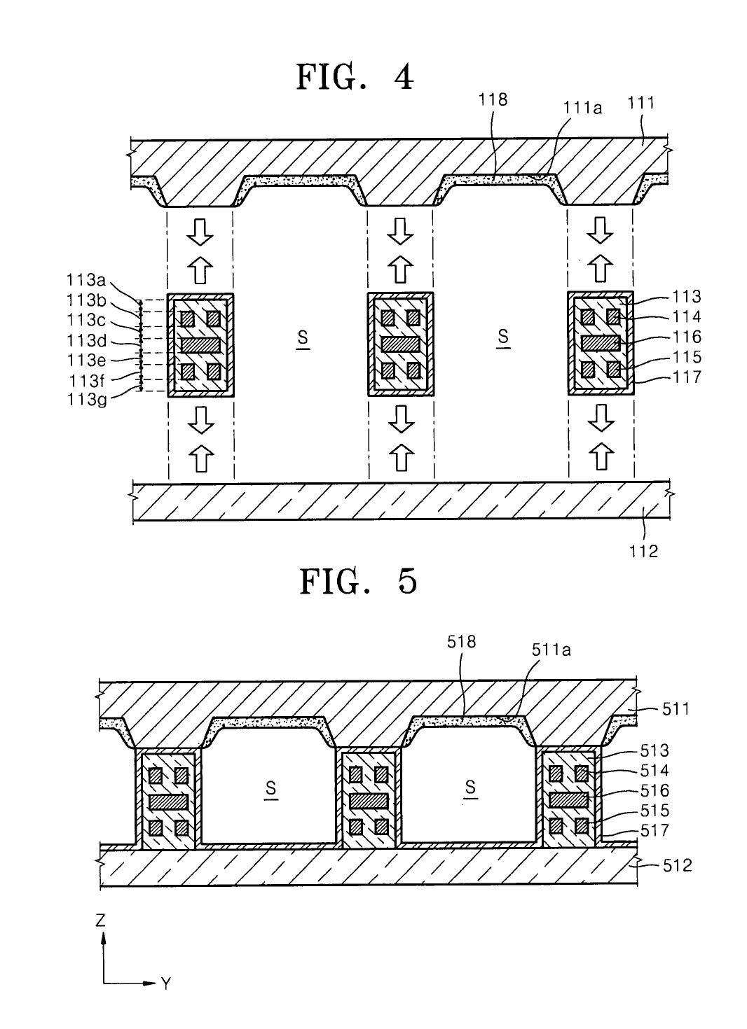

A method of fabricating the PDP 100 having the above structure will now be described with reference to FIG. 4.

Firstly, a first substrate 111 and a second substrate 112, which are disposed to be parallel to each other, are prepared.

In the case of the first substrate 111, a groove 111a is formed in a region corresponding to discharge cells S on one surface of the first substrate 111 through an etching process or a sand blasting process. A raw material for phosphor layers is applied to the groove 111a and is dried and baked, thereby forming phosphor layers 118.

In the case of the second substrate 112, other barrier ribs having substantially the same shape as that of the barrier ribs 113 are formed in a region corresponding to the barrier ribs 113 so that a discharge space can be enlarged, and other phosphor layers may also be additionally formed within other second barrier ribs.

The barrier ribs 113 which are disposed between the first substrate 111 and the second substrate 112 and partition the discharge cells S together with the first substrate 111 and the second substrate 112 and in which first through third discharge electrodes 114 to 116 are buried, are formed.

A process for forming the barrier ribs 113 will now be described in more detail. Firstly, a first sheet for barrier ribs 113a is prepared. A second sheet for barrier ribs 113b in which a first discharge electrode 114 is patterned, is stacked on one surface of the first sheet for barrier ribs 113a.

Subsequently, a third sheet for barrier ribs 113c having substantially the same shape as that of the first sheet for barrier ribs 113a is stacked on an outer surface of the second sheet for barrier ribs 113b. A fourth sheet for barrier ribs 113d in which a third discharge electrode 116 is patterned, is stacked on an outer surface of the third sheet for barrier ribs 113c.

Next, a fifth sheet for barrier ribs 113e having substantially the same shape as that of the first sheet for barrier ribs 113a is stacked on an outer surface of the fourth sheet for barrier ribs 113d. A sixth sheet for barrier ribs 113f in which the second discharge electrode 115 is patterned, is stacked on an outer surface of the fifth sheet for barrier ribs 113e. Subsequently, a seventh sheet for barrier ribs 113g having substantially the same shape as that of the first sheet for barrier ribs 113a is stacked on an outer surface of the sixth sheet for barrier ribs 113f.

In this way, the first through seventh sheets for barrier ribs 113a to 113g are sequentially stacked in the same direction as a direction where the PDP 100 is disposed, the first through third discharge electrodes 114, 115 and 116 are patterned in a selected region of the first through seventh sheets for barrier ribs 113a to 113g and are stacked to be disposed in a direction perpendicular to the direction where the PDP 100 is disposed.

Next, openings are formed on the first through seventh sheets for barrier ribs 113a to 113g through a punching or etching process, thereby forming the discharge cells S. As a result, the barrier ribs 113 in which the first through third discharge electrodes 114 to 116 are buried, are completed.

Subsequently, a protective layer 117 is formed on an outer surface of the barrier ribs 113 by sputtering magnesium oxide (MgO). The protective layers 117 are simultaneously formed on upper and lower surfaces of the barrier ribs 113 and on inner sidewalls of the barrier ribs 113 contacting the discharge cells S but is not limited to this.

The first substrate 111, the second substrate 112, and the barrier ribs 113 having a sheet shape disposed between the first substrate 111 and the second substrate 112, which are completed through independent processes in this way, are aligned as indicated by arrows of FIG. 4, and a sealing process is performed using a sealant such as a frit glass.

Exhaustion and discharge gas injection processes are performed, thereby fabricating a plasma display panel (PDP) 100. After the exhaustion and discharge gas injection processes, subsequent processes including aging may be additionally performed.

Referring to FIG. 5, a protective layer 517 may also be formed in the state where barrier ribs 513 are primarily attached to a second substrate 512 that opposes a first substrate 511 in which phosphor layers 518 are formed. In this case, the protective layer 517 may also be additionally formed on an inner surface of the second substrate 512 corresponding to discharge cells S. In addition, first through third discharge electrodes 514 to 516 are buried within the barrier ribs 513 and may be fabricated of substantially the same material as a material used in forming the second substrate 512 and may be formed with the second substrate 512 as a single body.

A method of driving a PDP 400 having the above structure will now be described with reference to FIGS. 1 through 3.

Firstly, an address discharge occurs between the first discharge electrode 114 and the third discharge electrode 115, and discharge cells S in which a sustain discharge will occur, are selected as the result of the address discharge.

After that, if an AC sustain discharge voltage is applied between the first discharge electrode 114 and the second discharge electrode 115 of the selected discharge cells S, a sustain discharge occurs between the first discharge electrode 114 and the second discharge electrode 115.

An energy level of a discharge gas excited by the sustain discharge is reduced and UV rays are emitted. The UV rays excite phosphor layers 118. An energy level of the excited phosphor layers 118 is reduced and visible rays are emitted, and images are realized by the visible rays.

The sustain discharge of the PDP 100 according to the current embodiment occurs in all side surfaces which define discharge cells, and a discharge area is relatively large.

In addition, the sustain discharge of the PDP 100 according to the current embodiments is formed as a closed loop shape along the side surfaces of the discharge cells S and are gradually diffused to central portions of the discharge cells S. As such, the volume of a region in which the sustain discharge occurs is increased and space charges within the discharge cells S contribute to emission.

As a result, the improvement of luminous efficiency of the PDP 100 can be achieved. In particular, since, in the current embodiment, the cross-section of each of the discharge cells S is circular, a sustain discharge uniformly occurs in all side surfaces of the discharge cells S.

In addition, since a sustain discharge is performed only in central portions of the discharge cells S, ion sputtering of phosphor layers caused by charge particles is prevented such that the same image is displayed for a long time and a permanent burning of an image is not formed.

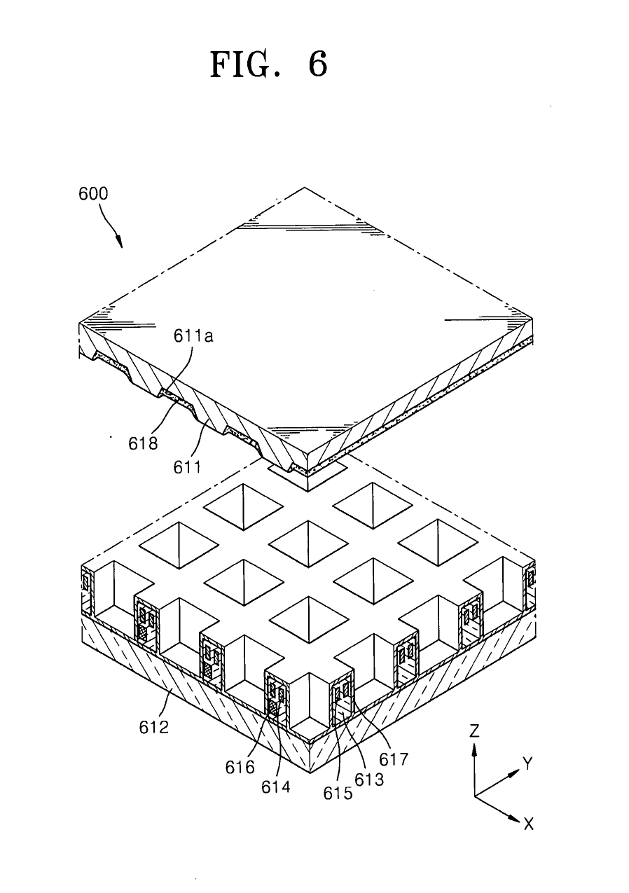

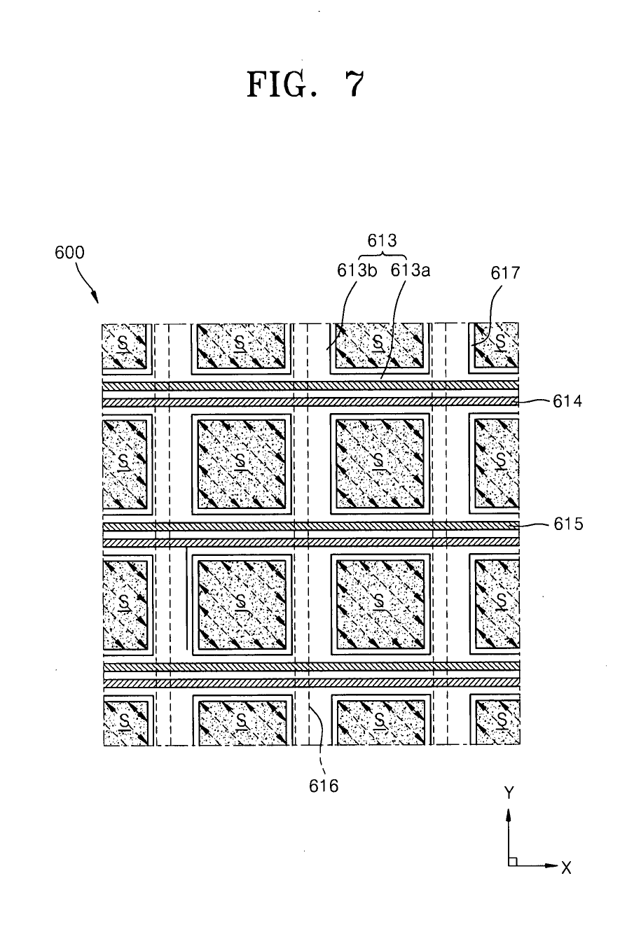

FIG. 6 is a partially-cut separated perspective view illustrating the state where a PDP 600 according to another embodiment is fabricated, and FIG. 7 is a plan view illustrating the state where discharge electrodes illustrated in FIG. 6 are disposed.

In this case, the PDP 600 has an opposed discharge structure in which 3-electrodes are buried within barrier ribs.

Referring to FIGS. 6 and 7, the PDP 600 includes a first substrate 611, a second substrate 612 which opposes the first substrate 611, and barrier ribs 613 disposed between the first substrate 611 and the second substrate 612.

The barrier ribs 613 include first barrier ribs 613a disposed in a X direction of the PDP 600, and second barrier ribs 613b extending from inner sidewalls of the first barrier ribs 613a in a direction in which the first barrier ribs 613a and the second barrier ribs 613b oppose each other and defining matrix-shaped discharge cells S.

First through third discharge electrodes 614, 615 and 616 are disposed within the barrier ribs 613. In the current embodiment, the first discharge electrode 614 and the second discharge electrode 615, respectively, correspond to an X electrode and a Y electrode, which cause a sustain discharge, and the third discharge electrode 616 corresponds to an address electrode which is disposed in a direction which crosses the second discharge electrode 615 and causes an address discharge. However, the number or shape of discharge electrodes is not limited to this.

In this case, the first discharge electrode 614 is disposed along one direction of each of the discharge cells S, and the second discharge electrode 615 extends from an opposed side of each of the discharge cells S in which the first discharge electrode 614 is disposed, along a direction which is parallel to the first discharge electrode 614.

The third discharge electrode 616 is disposed below the second discharge electrode 615 in a direction (a Z direction) perpendicular to a direction where the PDP 600 is disposed. The third discharge electrode 616 extends in a direction (a Y direction) which crosses the second discharge electrode 615.

Meanwhile, if the first discharge electrode 614 and the second discharge electrode 615 oppose each other between the discharge cells S, the first discharge electrode 614 and the second discharge electrode 615 are not limited to any one shape.

The first through third discharge electrodes 614, 615 and 616 are disposed not within each of the discharge cells S but are disposed along edges of each of the discharge cells S. Thus, the first through third discharge electrodes 614, 615 and 616 are not affected by an aperture of the PDP 600 and a metallic material having high conductivity such as silver paste or chrome-copper-chrome may be used for the first through third discharge electrodes 614, 615 and 616.

A protective layer 617 is formed on an outer surface of the barrier ribs 613. The protective layer 617 serves to protect breakdown of the barrier ribs 613 and to enlarge secondary electron emission. The protective layers 617 are formed on upper and lower surfaces of the barrier ribs 613, on inner sidewalls of the barrier ribs 613 contacting the discharge cells S and on an inner surface of the second substrate 612 corresponding to each of the discharge cells S but the present embodiments are not limited to this.

A plurality of grooves 611a are formed in a region corresponding to each of the discharge cells S on an inner surface of the first substrate 611. Phosphor layers 618 having a plurality of colors for colorization are formed within the grooves 611a.

In this embodiment, a plurality of sheets for barrier ribs are stacked on the barrier ribs 613 like in FIGS. 1 and 5. The first through third discharge electrodes 614 to 616 are patterned in a selected region of the sheets for barrier ribs.

A method of driving the PDP 600 having the above structure will now be described.

Firstly, an address discharge occurs between the second discharge electrode 615 and the third discharge electrode 616, and discharge cells S in which a sustain discharge will occur, are selected as the result of the address discharge.

If an AC sustain discharge voltage is applied to the first discharge electrode 614 and the second discharge electrode 615, a sustain discharge occurs between the first discharge electrode 614 and the second discharge electrode 615. An energy level of a discharge gas excited by the sustain discharge is reduced and UV rays are emitted.

The UV rays excite phosphor layers 618. An energy level of the excited phosphor layers 618 is reduced and visible rays are emitted, and images are realized by the visible rays.

As described above, in the plasma display panel (PDP) and the method of fabricating the same according to the present embodiments, dielectric walls which are disposed between substrates and in which a plurality of discharge electrodes are buried, are fabricated using a plurality of sheets through independent processes and are combined with the substrates such that processes are simplified and thermal deformation during a baking process is minimized.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a plurality of substrates including a first substrate and a second substrate, which oppose each other;
barrier ribs disposed between the substrates configured to define a plurality of discharge cells;
discharge electrodes buried within the barrier ribs configured to cause a discharge by an applied power; and
a plurality of phosphor layers formed within the discharge cells,
wherein the barrier ribs are formed of a plurality of sheets for barrier ribs and the discharge electrodes are patterned in selected regions of the sheets for barrier ribs.

2. The plasma display panel of claim 1, further comprising a protective layer formed on an outer surface of each barrier rib.

3. The plasma display panel of claim 2, wherein the protective layer comprises MgO.

4. The plasma display panel of claim 1, wherein the barrier ribs are formed by stacking a plurality of sheets for barrier ribs in the same direction as a direction in which the substrates are disposed.

5. The plasma display panel of claim 1, wherein the discharge electrodes are disposed in a direction perpendicular to the direction in which the substrates are disposed and are formed to surround circumferences of the discharge cells.

6. The plasma display panel of claim 5, wherein the discharge electrodes comprise:
a first discharge electrode;
a second discharge electrode extending in the same direction as that of the first discharge electrode and configured to cause a sustain discharge; and
a third discharge electrode extending in a direction which crosses the second discharge electrode and configured to cause an addressing discharge.

7. The plasma display panel of claim 1, wherein the discharge electrodes are disposed in a region where they face one another based on each of discharge cells.

8. The plasma display panel of claim 7, wherein the discharge electrodes are disposed on the same plane within the barrier ribs and are electrically insulated from one another.

9. The plasma display panel of claim 8, wherein the discharge electrodes comprise:
a first discharge electrode;
a second discharge electrode extending in the same direction as that of the first discharge electrode and configured to cause a sustain discharge; and
a third discharge electrode extending in a direction which crosses the second discharge electrode in upper or lower portions of the second discharge electrode and configured to cause an addressing discharge.

10. The plasma display panel of claim 1, wherein a groove having a predetermined depth is formed in a region corresponding to each of the discharge cells and wherein the phosphor layers are formed in the groove.

11. A method of fabricating a plasma display panel, the method comprising:
preparing a plurality of substrates including a first substrate and a second substrate, which are disposed to be parallel to each other;
preparing barrier ribs disposed between the substrates and partitioning a plurality of discharge cells and formed by stacking a plurality of sheets for barrier ribs in which a plurality of discharge electrode pairs are buried, in one direction; and
aligning the barrier ribs between the first and second substrates and forming a sealed discharge space by combining the barrier ribs.

12. The method of claim 11, wherein the preparing of the barrier ribs comprises:
forming the discharge electrodes in a selected region of a plurality of sheets for barrier ribs; and
sequentially stacking the sheets for barrier ribs and then forming openings in regions corresponding to discharge cells.

13. The method of claim 12, wherein the openings are processed by punching or etching.

14. The method of claim 11, further comprising forming a protective layer on an outer surface of each barrier rib.

15. The plasma display panel of claim 14, wherein the protective layer comprises MgO.

16. The method of claim 11, wherein the preparing of the substrates comprises:
forming a groove in a region corresponding to each of discharge cells on the substrates; and
forming a plurality of phosphor layers in the groove.
